(19) United States
(12) Patent Application Publication
(10) Pub. No.: US 2019/0185695 A1
(43) Pub. Date: Jun. 20, 2019

(54) METAL OXIDE INK, A METHOD FOR MANUFACTURING THE SAME AND A METHOD FOR MANUFACTURING AN ORGANIC ELECTRONIC STRUCTURE

(71) Applicant: City University of Hong Kong, Kowloon (HK)

(72) Inventors: Sai Wing Tsang, Shatin (HK); Binbin Yu, Mong Kok (HK); Yuanhang Cheng, Tai Wai (HK); Yuhui Ma, Henan Province (CN)

(21) Appl. No.: 15/846,611

(22) Filed: Dec. 19, 2017

(51) Int. Cl. C09D 11/38

(52) U.S. Cl. CPC C09D 11/38

(57) ABSTRACT

A metal oxide ink, a method for manufacturing the metal oxide ink and a method for manufacturing an organic electronic structure using the metal oxide ink. The metal oxide ink includes: a plurality of metal oxide particles suspended in a solvent; and a stabilizer arranged to stabilize the metal oxide particles with a plurality of ligands; wherein the plurality of ligands are arranged to self-dissociate upon a drying process of the solvent.

### TECHNICAL FIELD

The present invention relates to a metal oxide ink, a method for manufacturing the metal oxide ink and a method for manufacturing an organic electronic structure using the metal oxide ink, specifically, although not exclusively, to a metal oxide ink for use in fabrication of a metal oxide layer in an organic electronic structure without involving a high temperature annealing process.

### BACKGROUND

Electronic devices are components in various electrical appliances and equipment. Examples of these devices include light emitting diodes (LEDs), solar cells, photonic devices, transistors or computer processors which may be included to provide different functions in an electrical apparatus.

Although these devices are presented in different forms, all of them are generally comprise of layers of materials or structures. For example, in a transistor, it may consist of layers including an electrode layer, an insulator layer and a substrate layer, etc. The fabrication of each layer of these devices may require a precise dimension and a highly controlled purity such that the fabricated devices may operate as designed.

In order to achieve these requirements, fabrication of these layered structures may be carried out in a controlled environment, such as a fully enclosed chamber filled with inert gas or under vacuum. In addition, some fabrication processes may be accompanied with a high temperature condition for manipulating the physical/chemical properties of the layers of materials. Owing to these stringent fabrication steps, the production cost of each device is so high that rendering a high throughput fabrication being impossible.

### SUMMARY OF THE INVENTION

In accordance with a first aspect of the present invention, there is provided a metal oxide ink comprising: a plurality of metal oxide particles suspended in a solvent; and a stabilizer arranged to stabilize the metal oxide particles with a plurality of ligands; wherein the plurality of ligands are arranged to self-dissociate upon a drying process of the solvent.

In an embodiment of the first aspect, the plurality of stabilizer ligands are arranged to self-dissociate without being annealed in a high temperature process.

In an embodiment of the first aspect, the metal oxide particles are air-stable.

In an embodiment of the first aspect, the stabilizer includes a plurality of short-chain molecules.

In an embodiment of the first aspect, the stabilizer includes an amine.

In an embodiment of the first aspect, the stabilizer includes a low boiling point amine.

In an embodiment of the first aspect, the stabilizer includes at least one of propylamine, butylamine and isobutylamine

In an embodiment of the first aspect, a ratio of an amount of the stabilizer is less than 5% to an amount of the solvent.

In an embodiment of the first aspect, the plurality of metal oxide particles includes zinc oxide.

In an embodiment of the first aspect, the plurality of metal oxide particles includes nanoparticles.

In an embodiment of the first aspect, the solvent includes at least one of chloroform, chlorobenzene, 1,2-Dichlorobenzene and isopropanol.

In an embodiment of the first aspect, the metal oxide ink is a precursor material for use in three-dimensional printing.

In accordance with a second aspect of the present invention, there is provided a method for manufacturing a metal oxide ink in accordance with the first aspect, comprising the steps of: preparing the plurality of metal oxide particles suspended in the solvent; and the stabilizer with the plurality of metal oxide particles in the solvent.

In an embodiment of the second aspect, the step of preparing the plurality of metal oxide particles involves a hydrolysis reaction thereby synthesizing the plurality of metal oxide particles.

In an embodiment of the second aspect, the step of preparing the plurality of metal oxide particles comprises the step of: mixing potassium hydroxide solution and zinc acetate solution to synthesize a plurality of zinc oxide nanoparticles; separating the plurality of zinc oxide nanoparticles from the mixture of the potassium hydroxide solution and the zinc acetate solution; and dispersing the plurality of zinc oxide nanoparticles in the solvent.

In an embodiment of the second aspect, the zinc acetate solution includes zinc acetate dehydrate dissolved in methanol.

In an embodiment of the second aspect, the step of preparing the plurality of metal oxide particles comprises the step of stirring and heating the mixture of the potassium hydroxide solution and the zinc acetate solution.

In an embodiment of the second aspect, the mixture of the potassium hydroxide solution and the zinc acetate solution is heated at 60° C.

In accordance with a third aspect of the present invention, there is provided a method for manufacturing an organic electronic structure, comprising the step of applying a metal oxide ink in accordance with the first aspect on a surface of a substrate, thereby forming a layer of metal oxide on the substrate upon drying of the metal oxide ink.

In an embodiment of the third aspect, the process for manufacturing the electronic device does not involve an annealing process.

In an embodiment of the third aspect, the layer of metal oxide formed defines a conductive transporting layer in the electronic structure.

In an embodiment of the third aspect, the layer of metal oxide formed defines an electron transporting layer, a hole blocking layer, an electronic injecting layer or a channel layer in the electronic structure.

In an embodiment of the third aspect, the organic electronic structure includes at least one of an organic photovoltaic structure, an organic light-emitting diode structure, a quantum-dot light-emitting diode structure and an organic thin-film transistor structure.

### BRIEF DESCRIPTION OF THE DRAWINGS

Embodiments of the present invention will now be described, by way of example, with reference to the accompanying drawings in which:

FIG. 1 is an illustration of a metal oxide ink in accordance with an embodiment of the present invention;

FIG. 2 is a schematic diagram of an organic photovoltaic structure in accordance with an embodiment of the present invention;

FIGS. 3A, 3B, and 3C are illustrations of manufacturing respectively metal oxide nanoparticles, metal oxide nanoparticle ink of FIG. 1 and a layer of metal oxide in accordance with an embodiment of the present invention;

FIG. 4 is a set of photographic images showing the comparison of metal oxide ink of FIG. 1 and metal oxide nanoparticles suspension without stabilizer in 32 days;

FIG. 5 is a photographic image showing a photoluminance (PL) result of the samples of metal oxide nanoparticle in FIG. 4 after 32 days of storage;

FIGS. 6A, 6B, and 6C are plots showing UV-Vis absorption, PL performance, and X-ray diffraction pattern of the ZnO film fabricated using the metal oxide ink of FIG. 1; and

FIG. 7 is a plot showing current-voltage characteristics of the organic photovoltaic structure of FIG. 2 fabricated using the metal oxide ink of FIG. 1.

### DETAILED DESCRIPTION OF THE PREFERRED EMBODIMENT

The inventors have, through their own research, trials and experiments, devised that low-cost electronics may require high-throughput fabrication processes and materials with outstanding electronic properties. In some examples, solution-processed metal oxides (TiO₂, ZnO, SnO₂) may be applied, however, high temperature annealing process may be required so as to fine tune the material properties thereby improving the device performances.

For example, ZnO layer may be fabricated using ZnO sol-gel and nanoparticles. The ZnO nanoparticles may be stabilized by a stabilizer material or surface ligands to prevent aggregation of the nanoparticles forming ZnO clusters in the solution, which is not favourable for the fabrication of thin ZnO layers.

The surface ligands, whilst perform passivation to the ZnO nanoparticles, may affect the electrical performance of the metal oxide layer form from such metal oxide solution. Thus it is necessary to remove the surface ligands from the surface of the ZnO nanoparticles such that the fabricated ZnO layer will operate as desired.

In one example fabrication process, after a deposition of a solvent containing the ZnO nanoparticles on a substrate, the substrate may be annealed at high temperature (such as over 400° C.) to remove the surface ligands from the surface of the ZnO nanoparticles. However, the high temperature process also cause a sintering effect to the ZnO nanoparticles, therefore severely limits the application of solution processed metal oxide thin film in different devices.

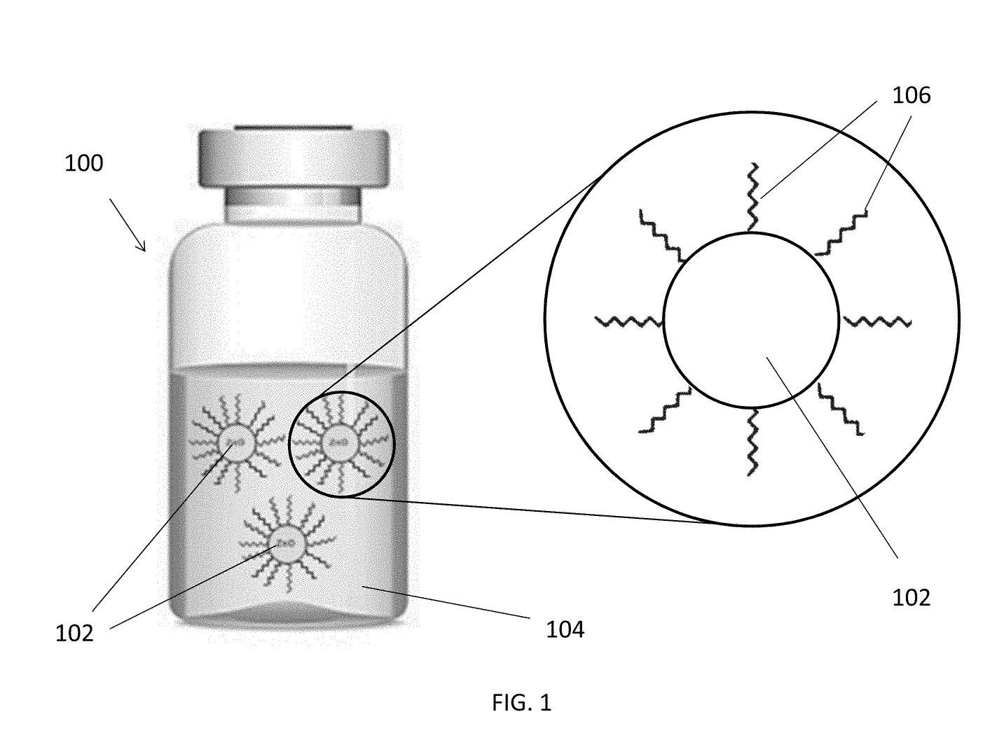

With reference to FIG. 1, there is shown an embodiment of a metal oxide ink 100 comprising: a plurality of metal oxide particles 102 suspended in a solvent 104; and a stabilizer arranged to stabilize the metal oxide particles with a plurality of ligands 106; wherein the plurality of ligands 106 are arranged to self-dissociate upon a drying process of the solvent 104.

In this embodiment, the metal oxide ink 100 is a solution containing a plurality of nanoparticles such as ZnO nanoparticles 102 or nanoparticles of other metal oxide suspending in a solvent 104. Upon drying process, solvents such as choloform, chlorobenzene, 1,2-dichlorobenzene and isopropanol, is removed from the solution 100 leaving the nanoparticles 102 on the applied surface thereby forming a thin film of metal oxide, and the layer of metal oxide formed may operate as different components in different device structures, which may depend on the work functions and the band gaps of the metal oxide and the adjacent layers in a device structure.

For example, the layer of metal oxide formed may define an electron transporting layer, a hole blocking layer, an electronic injecting layer or a channel layer in the electronic structure, wherein the organic electronic structure includes an organic photovoltaic structure, an organic light-emitting diode structure, a quantum-dot light-emitting diode structure or an organic thin-film transistor structure.

Preferably, the layer of metal oxide formed may define a conductive transporting layer in the electronic structure. For example, in an LED device or a photovoltaic device, light may pass through the layer of metal oxide such that light emitted from the active layer may be extracted from the device or light from the environment may be absorbed by the active material.

Referring to FIG. 1, the stabilizer includes a plurality of short-chain molecule or an amine (or molecules with an amine functional group). The stabilizer may passivate the ZnO nanoparticles 102 suspended in the solvent 104 such that the oxide particles are air-stable. In addition, the stabilizer also prevents nanoparticles 102 from aggregating to form cluster in the solution 100. The aggregates or clusters are not preferable in smooth and conformal thin-film formation.

Preferably, the amine includes a low boiling point amine, such as but not limited to propylamine, byutylamine and isobutylamine. These amine groups are arranged to self-dissociate upon a drying process of the solvent 104 in the ink 100 and such self-dissociation of the amines does not involve a high temperature annealing process. With such advantageous feature, annealing is not required in a process for manufacturing an electronic device having a layer of metal oxide layer formed by drying the metal oxide ink 100.

In one example embodiment, the amount (weight) of the stabilizer or amine is less than 5% to that of the solvent in ratio. Alternatively, such amount may be in the range of 1% to 10% by volume ratio.

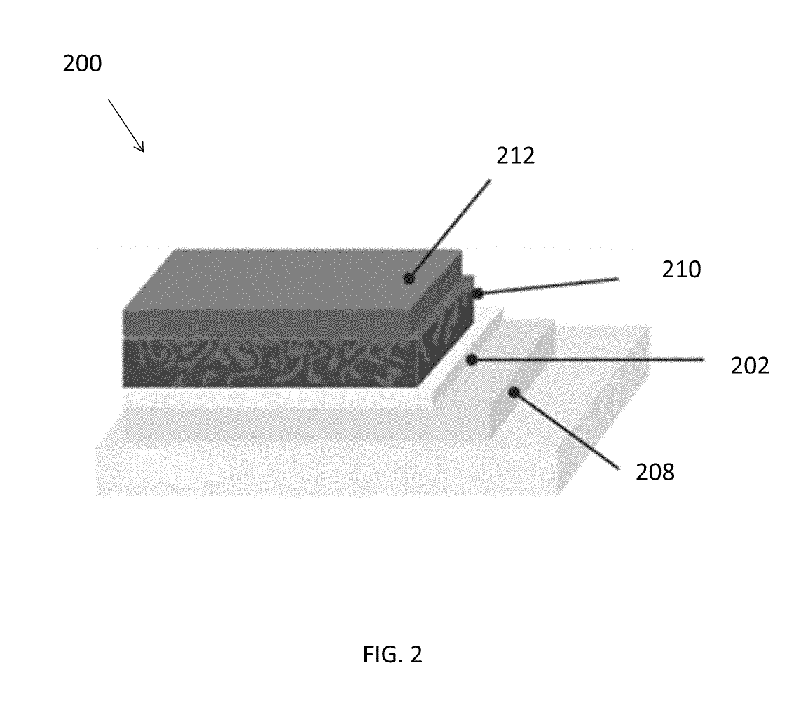

With reference to FIG. 2, there is provided an example embodiment of an organic electronic structure 200. The electronic structure 200 includes a layer of metal oxide 202 on the ITO/glass substrate 208 which is formed by drying the metal oxide ink 100 applied thereon. Preferably, the process for manufacturing the electronic device 200 does not involve an annealing process.

In one fabrication process of an example organic photovoltaic (OPV) structure 200, an ITO-glass substrate 208 may be cleaned by sonication in deionized water, acetone and ethanol for 15 minutes each, followed by UV ozone treatment for 20 minutes. Alternatively, other substrates such as quartz, glass, or other transparent conductive oxide glass may be used as the substrate.

Metal oxide ink 100 may be prepared prior to the manufacturing of the OPV structure 200, and may be spin-coated onto the ITO surface at 4000 rpm for 40 seconds. The spun-on ZnO ink 100 may be left dried in air or vacuum to remove the solvents 104 from the deposited ZnO thin film 202. A 30 nm thick layer of ZnO may be formed on the ITO-glass substrate.

Subsequently, a P₃HT/PC₇₁BM donor/acceptor blend film (active layer) 210 may be spin-coated at 1500 rpm for 40 seconds. Finally, a 5 nm MoOₓ and 100 nm Ag electrode 212 may be deposited by thermal evaporation at a base pressure of 10⁻⁷ Torr. Other donor/acceptor/conductive materials may be deposited in other example devices.

Alternatively, the electron transport layer and/or the active layer(s) may be applied on the substrate using different solution process, such as but not limited to inkjet printing, blade coating, screen printing, spray coating or any solution process as appreciated by a person skilled in the art. The electrodes may also be deposited using other physical/chemical vapor deposition methods or any of the abovementioned solution process methods.

In this example, the process for manufacturing such OPV structure 200 does not involve an annealing process therefore does not cause sintering to the ZnO nanoparticles 102 which may degrade the conductivity or the transparency of the film 202. In addition, energy and cost for manufacturing such OPV structure 200 may be further reduced by not including a high temperature annealing process, thereby minimizing the energy payback time for the fabricated OPV device.

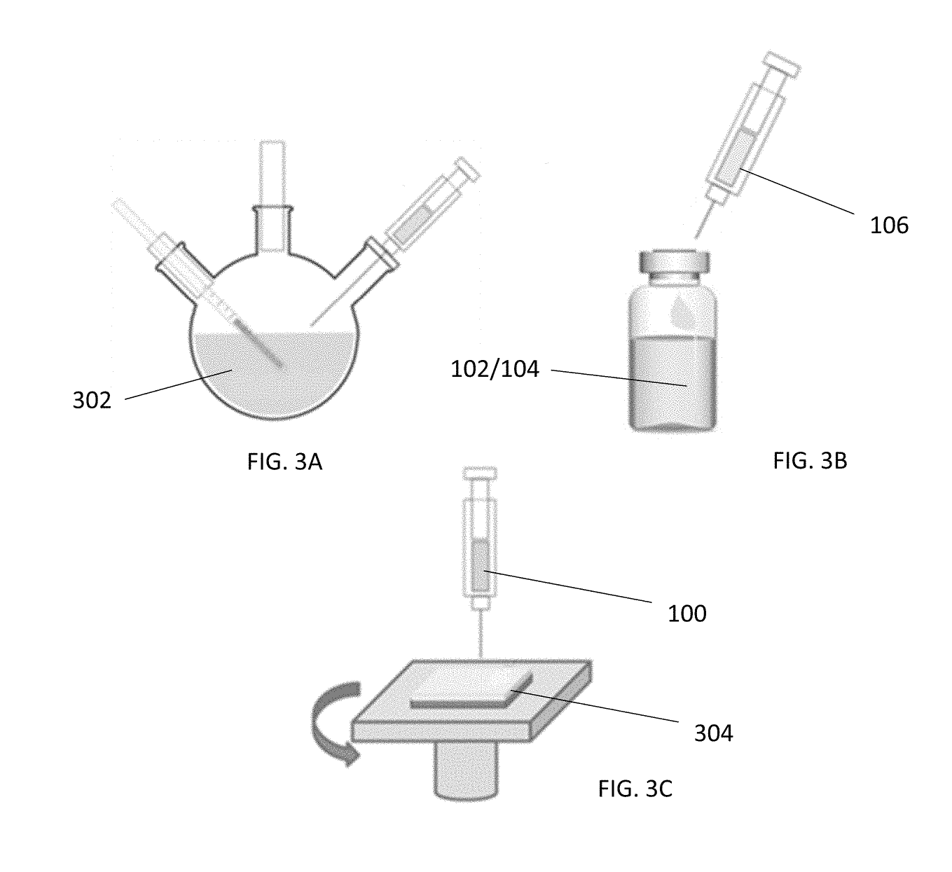

With reference to FIGS. 3A to 3C, there is shown an illustrative example of manufacturing ZnO nanoparticles 102, a ZnO nanoparticle ink 100 with the synthesized ZnO nanoparticles 102 and a ZnO layer 202 formed by using such ZnO nanoparticle ink 100.

To produce the metal oxide ink 100, the process may be started by preparing the plurality of metal oxide particles 102 suspended in the solvent 104, preferably by mixing a hydroxide solution and a metal acetate solution to carrying out a hydrolysis reaction between the mixed solution to produce the metal oxide nanoparticles 102. The reaction may be assisted by stirring and heating the mixed solution, and the insoluble nanoparticles 102 may be separated from the solvent 104. The metal oxide nanoparticles 102 may be further dispersed in an organic solvent 104 to produce a metal oxide particle suspension.

Referring to FIG. 3A, in one example embodiment, the precursor materials 302 including zinc acetate dehydrate (2.95 g) and potassium hydroxide (KOH) (1.48 g) are dissolved in methanol (65 mL) and loaded into three neck flasks respectively. The flask with zinc acetate dehydrate solution is immersed in an oil bath at 55-65° C., preferably at 60° C. Then KOH solution is added into zinc acetate solution slowly. The mixed solution is stirred vigorously till the transparent solution become turbid, then stirring for a period ranging from half an hour to two hours. Finally, the ZnO nanoparticles 102 may be centrifuged and washed several times, followed by dispersing in organic solvent such as chloroform, chlorobenzene, 1,2-dichlorobenzene, isopropanol.

Referring to FIG. 3B, the method for manufacturing the metal oxide ink 100 further comprises the step of mixing a stabilizer 106, such as amine (1%-10% volume ratio), with the plurality of metal oxide particles 102 in the solvent 104, thereby producing an air-stable ZnO ink 100.

Referring to FIG. 3C, the air-stable ZnO ink 100 may be applied on a device substrate 304, such as quartz, glass, indium tin oxide (ITO) coated glass, using a solution deposition method under an air ambient. In this example, ZnO ink with a concentration ranging from 25 mg/mL to 100 mg/mL is applied with spin coating method with a spin speed ranging from 1000 rpm to 4000 rpm to form a ZnO film with various thicknesses. Upon drying of the metal oxide ink 100, the solvent 104 evaporates and thereby forming a layer of ZnO on the surface of the substrate 304.

In yet an alternative embodiment, the metal oxide ink 100 may be applied as a precursor material for use in three-dimensional (3D) printing, in which the 3D metal oxide structure may be fabricated.

The chemical/physical properties of the ZnO thin films may depend on the size of the ZnO nanoparticles.

Those properties may be tailor made for specific applications. On the other hand, the stabilizer is generally used to stabilize any size of ZnO nanoparticles for storage, especially in ambient air condition. In addition, the stabilizer will be self-dissociated after depositing the ZnO film, which would not affect the properties of the ZnO nanoparticles.

These embodiments may be advantageous in that organic electronic devices nay be fabricated in air-ambient, such as large area organic solar cell or organic LED may be fabricated using roll-to-roll process or doctor blading in ambient air without the use of sophisticated vacuum equipment.

Advantageously, with the air-stable ZnO nanoparticle ink, electronic devices can be fabricated by high throughput roll-to-roll technique, which leads to large area and flexible organic electronic devices fabrications with lower manufacturing cost. By eliminating the high temperature annealing process may further minimize the cost as well as energy used in manufacturing organic electronic devices.

In addition, amines are soluble in organic solvent like ether, benzene and alcohol and only small amount of amine is added to the solvent, the ZnO nanoparticles may be dissolved in any polar solvent and may be relatively safe to humans as well as the environment.

The inventors also performed experiments to evaluate the metal oxide ink in accordance with the embodiments of the present invention. It is observed that the stabilizer may act as the surface ligand to prevent the ZnO nanoparticles from aggregation in air. Without the stabilizer the ZnO nanoparticles aggregate and the solution turns milky.

In contrast, in the metal oxide ink according to the embodiments of the present invention, the stabilizer with the amine group may effectively passivate the ZnO nanoparticles, the low molecular weight (short chain) of the stabilizer enables self-dissociation after film forming without thermal annealing.

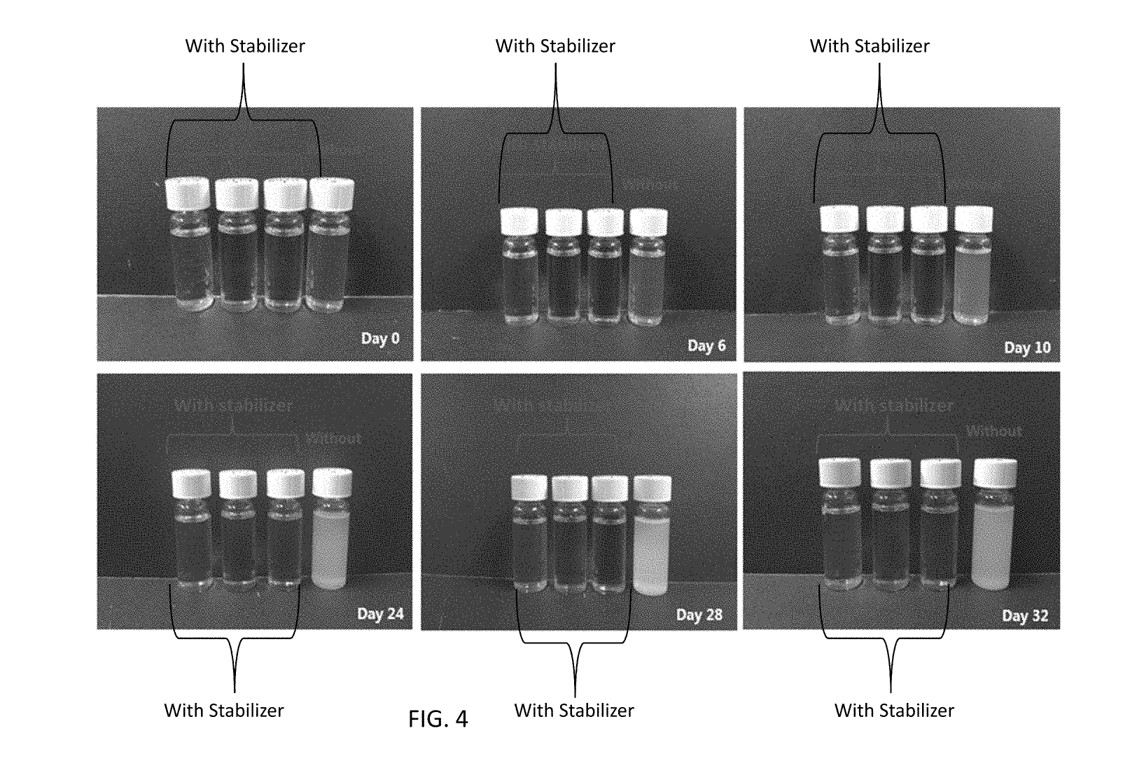

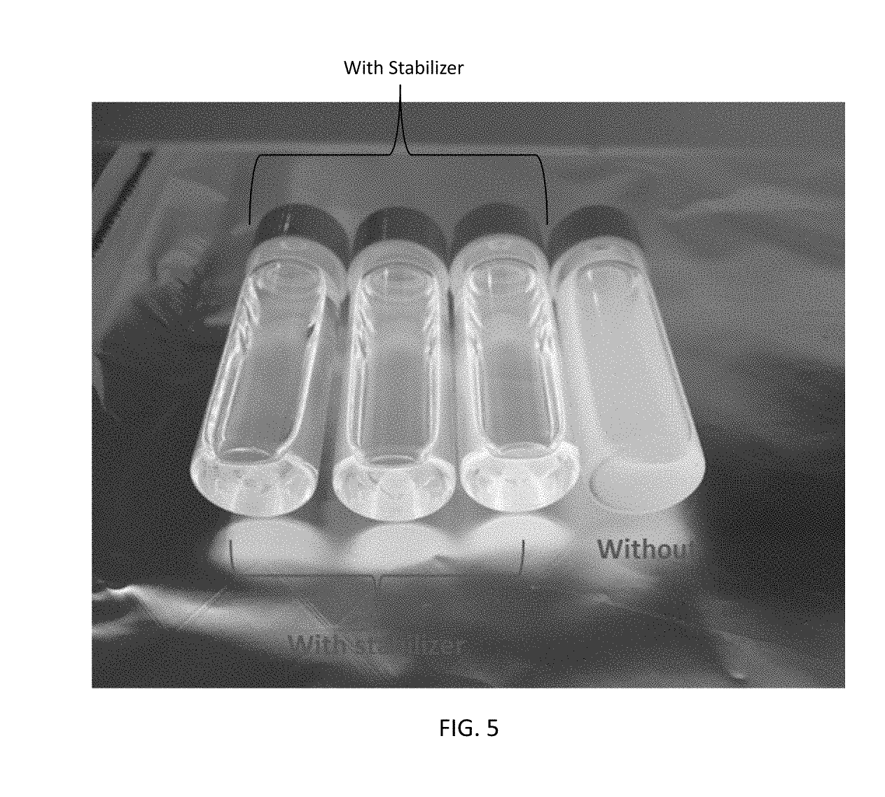

With reference to FIG. 4, there is shown photographic images of four samples of metal oxide ink stored in reagent bottles in 32 days. It is observable that the metal oxide ink with stabilizers remains clear without nanoparticle aggregation. On the other hand, the solution without stabilizer turns milky immediately due to nanoparticle aggregation.

With reference to FIG. 5, there is shown a photoluminance (PL) result of the samples in FIG. 4 after 32 days of storage. The ZnO nanoparticle ink with stabilizer after one month shows strong PL intensity, indicating the nanoparticles are well separated. On the other hand, the solution without stabilizer shows very weak PL intensity.

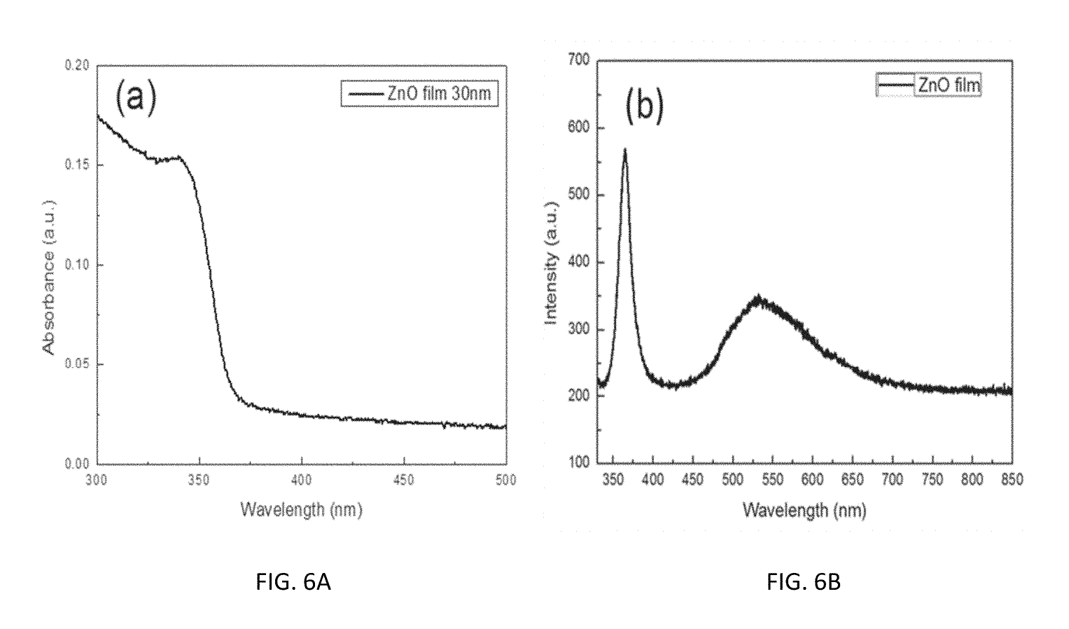

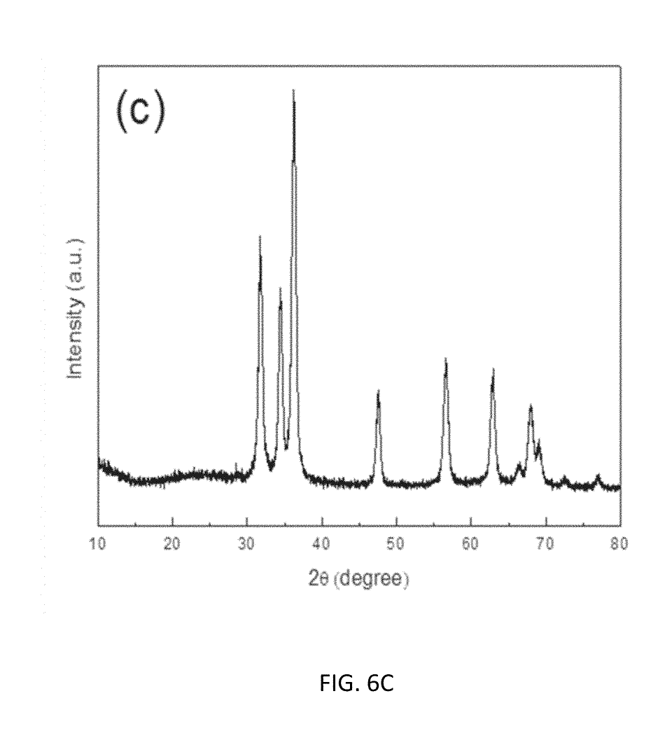

With reference to FIGS. 6A to 6C, there is shown characterization results of ZnO thin film deposited with the ZnO nanoparticle ink, including UV-Vis absorption (FIG. 6A), photoluminance (FIG. 6B), and X-ray diffraction pattern (FIG. 6C), all of these results indicate the excellent quality of the ZnO film. These results support that the stabilizers may be self-dissociated after film deposition without affect the properties of ZnO.

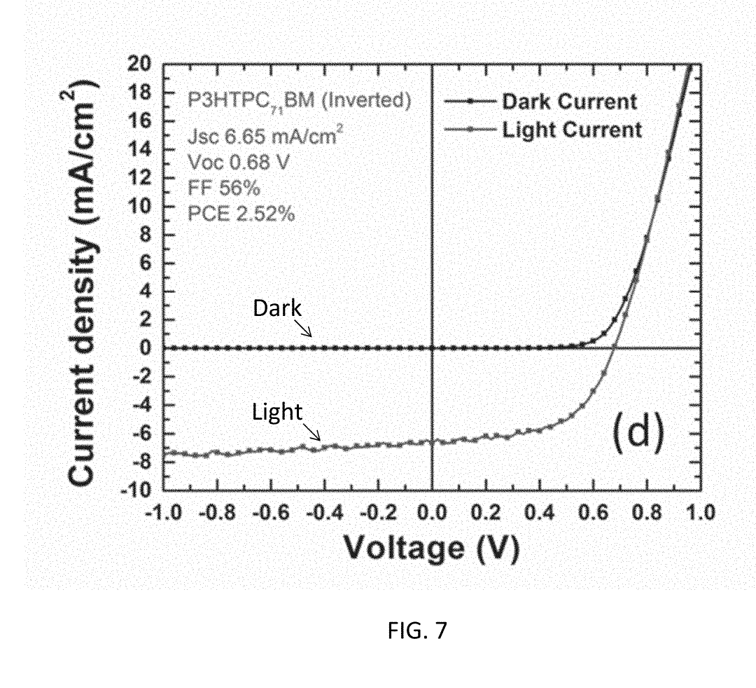

In addition, the application of the ZnO film on OPV also shows an excellent performance. With reference to FIG. 7, an OPV device having a structure of ITO/ZnO/P₃HT:PCBM/MoOₓ/Ag (similar to that of FIG. 2) obtained a conversion efficiency of 2.5%.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A metal oxide ink comprising:
a plurality of metal oxide particles suspended in a solvent; and
a stabilizer arranged to stabilize the metal oxide particles with a plurality of ligands;
wherein the plurality of ligands are arranged to self-dissociate upon a drying process of the solvent.

2. The metal oxide ink in accordance with claim 1, wherein the plurality of stabilizer ligands are arranged to self-dissociate without being annealed in a high temperature process.

3. The metal oxide ink in accordance with claim 1, wherein the metal oxide particles are air-stable.

4. The metal oxide ink in accordance with claim 1, wherein the stabilizer includes a plurality of short-chain molecules.

5. The metal oxide ink in accordance with claim 1, wherein the stabilizer includes an amine.

6. The metal oxide ink in accordance with claim 3, wherein the stabilizer includes a low boiling point amine.

7. The metal oxide ink in accordance with claim 3, wherein the stabilizer includes at least one of propylamine, butylamine and isobutylamine

8. The metal oxide ink in accordance with claim 3, wherein a ratio of an amount of the stabilizer is less than 5% to an amount of the solvent.

9. The metal oxide ink in accordance with claim 1, wherein the plurality of metal oxide particles includes zinc oxide.

10. The metal oxide ink in accordance with claim 8, wherein the plurality of metal oxide particles includes nanoparticles.

11. The metal oxide ink in accordance with claim 1, wherein the solvent includes at least one of chloroform, chlorobenzene, 1,2-dichlorobenzene and isopropanol.

12. The metal oxide ink in accordance with claim 1, wherein metal oxide ink is a precursor material for use in three-dimensional printing.

13. A method for manufacturing a metal oxide ink including a plurality of metal oxide particles suspended in a solvent, and a stabilizer arranged to stabilize the metal oxide particles with a plurality of ligands, wherein the plurality of ligands are arranged to self-dissociate upon a drying process of the solvent, the method comprising the steps of:
preparing the plurality of metal oxide particles suspended in the solvent; and
mixing the stabilizer with the plurality of metal oxide particles in the solvent.

14. The method for manufacturing a metal oxide ink in accordance with claim 13, wherein the step of preparing the plurality of metal oxide particles involve a hydrolysis reaction thereby synthesizing the plurality of metal oxide particles.

15. The method for manufacturing a metal oxide ink in accordance with claim 14, wherein the step of preparing the plurality of metal oxide particles comprising the step of:
mixing potassium hydroxide solution and zinc acetate solution to synthesize a plurality of zinc oxide nanoparticles;
separating the plurality of zinc oxide nanoparticles from the mixture of the potassium hydroxide solution and the zinc acetate solution; and
dispersing the plurality of zinc oxide nanoparticles in the solvent.

16. The method for manufacturing a metal oxide ink in accordance with claim 15, wherein the zinc acetate solution includes zinc acetate dehydrate dissolved in methanol.

17. The method for manufacturing a metal oxide ink in accordance with claim 15, wherein the step of preparing the plurality of metal oxide particles comprising the step of stirring and heating the mixture of the potassium hydroxide solution and the zinc acetate solution.

18. The method for manufacturing a metal oxide ink in accordance with claim 17, wherein the mixture of the potassium hydroxide solution and the zinc acetate solution is heated at 60° C.

19. A method for manufacturing an organic electronic structure, comprising the step of applying a metal oxide ink on a surface of a substrate, thereby forming a layer of metal oxide on the substrate upon drying of the metal oxide ink, the metal oxide ink including a plurality of metal oxide particles suspended in a solvent, and a stabilizer arranged to stabilize the metal oxide particles with a plurality of ligands, wherein the plurality of ligands are arranged to self-dissociate upon a drying process of the solvent.

20. The method for manufacturing an organic electronic structure in accordance with claim 19, wherein the process for manufacturing the electronic device does not involve an annealing process.

21. The method for manufacturing an organic electronic structure in accordance with claim 19, wherein the layer of metal oxide formed defines a conductive transporting layer in the electronic structure.

22. The method for manufacturing an organic electronic structure in accordance with claim 19, wherein the layer of metal oxide formed defines an electron transporting layer, a hole blocking layer, an electronic injecting layer or a channel layer in the electronic structure.

23. The method for manufacturing an organic electronic structure in accordance with claim 19, wherein the organic electronic structure includes at least one of an organic photovoltaic structure, an organic light-emitting diode structure, a quantum-dot light-emitting diode structure and an organic thin-film transistor structure.
